(19) United States
(12) Patent Application Publication
(10) Pub. No.: US 2019/0141787 A1
(43) Pub. Date: May 9, 2019

(54) TEMPERATURE MEASURING DEVICE, COOKING APPARATUS AND COOKING SYSTEM

(71) Applicant: COPRECI, S.COOP., Aretxabaleta (ES)

(72) Inventors: José Ignacio MUGICA ODRIOZOLA, BERGARA (ES); Aitor ZABALO BAYON, ARRASATE (ES); Félix QUEREJETA ANDUEZA, HENDAYE (FR)

(21) Appl. No.: 16/239,816

(22) Filed: Jan. 4, 2019

Related U.S. Application Data
(63) Continuation of application No. PCT/EP2017/064691, filed on Jun. 15, 2017.

(30) Foreign Application Priority Data
Jul. 4, 2016 (ES) P201630907

(51) Int. Cl. H05B 1/02; H05B 3/68; H05B 6/06; H04B 5/00

(52) U.S. Cl. CPC H05B 1/0266; H05B 3/685; H05B 6/062; H05B 2213/07; H04B 5/0031; H05B 2213/06; H04B 5/0037

(57) ABSTRACT

According to some implementations temperature measuring devices, cooking apparatuses, and cooking systems are provided. The cooking system may include wireless transmission means for transmitting the temperature measured by the measuring device to the cooking apparatus. The transmission means includes an active communication unit arranged in the cooking apparatus and a passive communication unit arranged in the measuring device, both communication units being configured for communicating with one another, the active communication unit generating an electromagnetic field for energizing the passive communication unit, such that as a result of the electromagnetic field the measuring device can measure the cooking temperature and transmit it to the cooking apparatus.

### CROSS-REFERENCE TO RELATED APPLICATIONS

This application relates to and claims the benefit and priority to International Application No. PCT/EP2017/064691, filed Jun. 15, 2017, which relates to and claims the benefit and priority to Spanish Application No. P201630907, filed Jul. 4, 2016.

### TECHNICAL FIELD

The present invention relates to a temperature measuring device, a cooking apparatus, and a cooking system.

### BACKGROUND

The possibility of knowing the cooking temperature of a food and/or of the cooking medium of a food allows cooking the food in an optimal manner.

Cooking systems comprising a measuring device for measuring a cooking temperature are known. For example, EP2945460A1 discloses a cooking system comprising a cooking apparatus with a plurality of cooking zones and a controller. The cooking system also comprises a temperature sensor. The temperature sensor transmits the cooking temperature to the controller of the cooking apparatus. The controller can thereby adjust the power of the cooking zone in question. Communication between the temperature sensor and the cooking apparatus can be through wireless technology.

### SUMMARY OF THE DISCLOSURE

A first aspect relates to a temperature measuring device comprising at least one temperature sensor for measuring a cooking temperature and wireless transmission means for transmitting the temperature measured by the at least one temperature sensor to a cooking apparatus.

The transmission means comprise a passive communication unit configured for communicating with an active communication unit of the cooking apparatus, the active communication unit generating an electromagnetic field for energizing the passive communication unit, such that as a result of the electromagnetic field the measuring device can measure the cooking temperature and transmit it to the cooking apparatus.

A second aspect relates to a cooking apparatus comprising at least one cooking zone and wireless transmission means for receiving the temperature measured by a measuring device comprising at least one temperature sensor.

The transmission means comprises an active communication unit arranged inside the cooking apparatus, configured for communicating with a passive communication unit of the measuring device, the active communication unit generating an electromagnetic field for energizing the passive communication unit, such that as a result of the electromagnetic field the measuring device can measure the cooking temperature and transmit it to the cooking apparatus.

A third aspect relates to a cooking system comprising a cooking apparatus and a temperature measuring device such as those described above.

Given that the measuring device is fed by the electromagnetic field generated by the active communication unit of the cooking apparatus, the measuring device of the invention does not require any type of battery or connection to a power source to measure the cooking temperature or to transmit the cooking temperature.

These and other advantages and features will become evident in view of the drawings and the detailed description.

### BRIEF DESCRIPTION OF THE DRAWINGS

FIG. 1 shows a perspective view of a cooking system according to one embodiment, the measuring device being separate from the cooking apparatus.

FIG. 2 is a perspective view of the cooking system of FIG. 1, wherein the measuring device is arranged in the contact area of the cooking apparatus.

FIG. 3 is a partial cross-section view of the cooking system of FIG. 1, wherein the measuring device is arranged in the contact area of the cooking apparatus.

FIG. 4 is a detailed view of FIG. 3.

FIG. 5 is a perspective view of the measuring device of FIG. 1.

FIG. 6 is a cross-section view of the measuring device of FIG. 1.

### DETAILED DESCRIPTION

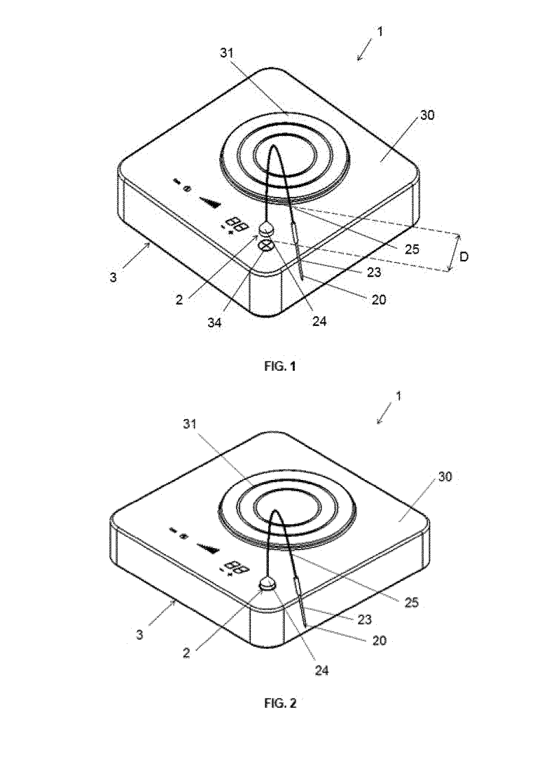

FIGS. 1 and 2 show an embodiment of the cooking system 1 according to the invention.

The cooking system 1 comprises a cooking apparatus 3 comprising a cooking zone 31. The cooking apparatus can be of any type known by the person skilled in the art, for example an induction cooktop, a glass ceramic cooktop or a gas cooking apparatus or a barbecue. In the embodiment shown in the drawings, the cooking apparatus 3 is a portable induction cooktop comprising a single cooking zone. In other embodiments, the cooking apparatus can comprise a plurality of cooking zones.

The cooking system 1 also comprises a temperature measuring device 2 comprising a temperature sensor 20 for measuring a cooking temperature. The cooking temperature can refer to the temperature of a food that is being cooked or to the medium in which the food is being cooked. For example, the sensor can be arranged inside a piece of meat that is being cooked in order to cook the meat to the desired point of doneness, but it also can be arranged in the oil in which a food is being fried so that the temperature of the oil is maintained at the optimal temperature. Preferably, the type of sensor used is a resistive temperature detector, for example a PT 100. This type of sensor comprises a resistance the value of which varies depending on temperature. In this embodiment, the temperature sensor 20 is arranged in a needle-shaped carrier 23. The needle shape of the carrier 23 makes the possibility of introducing the temperature sensor 20 into the food that is being cooked easier.

In other possible embodiments, the measuring device can comprise more than one temperature sensor, for example it can comprise two temperature sensors, such that a first sensor can measure the temperature of the food that is being cooked, and a second sensor can measure the cooking temperature of the medium in which the food is being cooked.

The cooking apparatus 3 and the measuring device 2 comprise wireless transmission means for transmitting the cooking temperature measured by the temperature sensor 20 of the measuring device 2 to the cooking apparatus 3.

The transmission means comprise an active communication unit 32 arranged inside the cooking apparatus 3 and a passive communication unit 21 arranged in the measuring device 2, both communication units being configured for communicating with one another, the active communication unit 32 generating an electromagnetic field for energizing the passive communication unit 21, such that as a result of the electromagnetic field, the measuring device 2 can measure the cooking temperature and transmit it to the cooking apparatus 3. This may entail the active communication unit 32 receiving from the passive communication unit 21 data indicative of the measured cooking temperature and then transmitting the data to a temperature controller of the cooking apparatus that controls the turning on and off of the cooking zone 31.

The measuring device therefore does not require any type of battery or any connection to a power source to measure the cooking temperature or to transmit the cooking temperature. For measuring the cooking temperature and transmitting the cooking temperature to the cooking apparatus, the measuring device is energized by the electromagnetic field generated by the active communication unit of the cooking apparatus.

Preferably, the technology used by the transmission means is near field communication (NFC) technology. The active communication unit 32 may be an active NFC antenna and the passive communication unit 21 may be a passive NFC antenna. According to ISO 14443, NFC is performed by means of induction in a magnetic field, wherein two spiral antennas are placed within their respective near fields. One of the NFC operating modes is passive communication. In passive NFC, only one device, in this case the active communication unit 32, generates the electromagnetic field and the other one, in this case the passive communication unit 21, uses the load modulation to transfer the data. The communication initiator is in charge of generating the electromagnetic field.

In other embodiments, the transmission means can use other technologies known by the person skilled in the art, provided that the active communication unit can energize the measuring device.

In this embodiment, the cooking system 1 comprises positioning means configured for aligning the passive communication unit 21 with respect to the active communication unit 32, such that the passive communication unit 21 is assured to be aligned with the active communication unit 32. It is important for the passive communication unit 21 to be aligned with the active communication unit 32, since NFC technology requires both communication units to be arranged close to one another so that communication is correct.

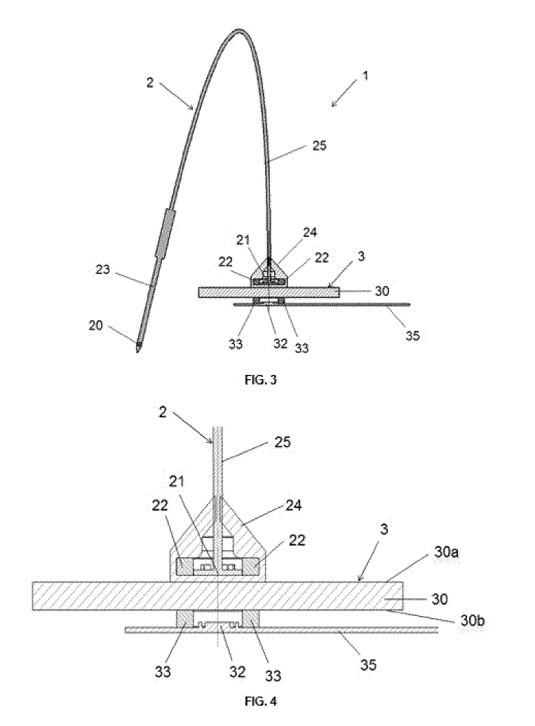

In this embodiment, the positioning means comprise magnetic means arranged in the cooking apparatus 3 and in the measuring device 2, such that the passive communication unit 21 of the measuring device 2 is aligned with the active communication unit 32 of the cooking apparatus 3 when both communication units approach to one another, as observed in FIGS. 3 and 4.

In this embodiment, the positioning means of the cooking apparatus 3 comprise a ring-shaped magnet 33, the active communication unit 32 being arranged in the center of the ring-shaped magnet 33, and the positioning means of the measuring device 2 comprise a ring-shaped magnet 22, the passive communication unit 21 being arranged in the center of the ring-shaped magnet 22.

As described above, in this embodiment the cooking apparatus 3 is a portable induction cooktop. The induction cooktop comprises a hotplate 30 where the cooking zone 31 is arranged. The assembly formed by the magnet 33 of the cooking apparatus 3 and the active communication unit 32 are likewise arranged in the lower part 30b of the hotplate 30. A marked reading area 34 is defined in the upper part 30a of the hotplate 30. The reading area 34 corresponds with the location of the active communication unit 32 and the magnet 33. No element needs to be added to the upper part 30a of the hotplate 30, as indicating the location of the reading area 34 by means of a marking, for example, is enough, so the hotplate 30 is flat on the entire upper part 30a, an easy-to-clean solution being obtained. As shown in FIG. 1, the the active communication unit is located laterally of the cooking zone 31 by a distance D so that the active communication unit 32 is not located in or below the cooking zone 31.

In other embodiments, the positioning means of both the cooking apparatus and the measuring device can comprise a magnet with another geometrical shape or a plurality of magnets, provided that they perform the function of the passive communication unit of the measuring device being aligned with the active communication unit of the cooking apparatus when both communication units approach to one another. In these embodiments, the active communication unit as well as the passive communication unit could be located in the area of the magnet or magnets.

In another possible embodiment, the positioning means of the cooking apparatus can be replaced with a ferromagnetic element cooperating with the magnet of the measuring device.

In other possible embodiments, simpler positioning means could also be used, dispensing with magnets and ferromagnetic materials. For example, a housing for partially housing the measuring device could be made in the cooking apparatus.

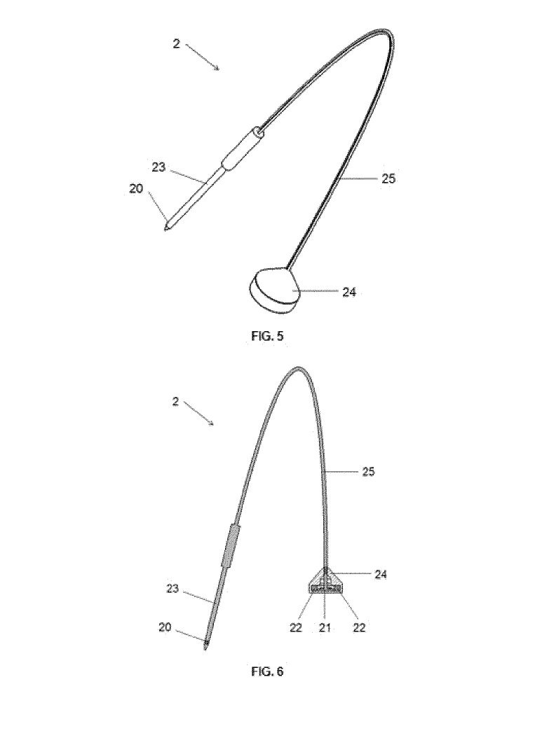

The measuring device 2 of this embodiment, shown in detail in FIGS. 5 and 6, comprises a body injected over the passive communication unit 21, the injected body 24 encasing the passive communication unit 21. In this embodiment, the body 24 also encases the magnet 22 of the measuring device 2 and a treatment circuit, not shown in the drawings, adapting the signals between a temperature sensor 20 and the passive communication unit 21. The body 24 is connected to the temperature sensor 20 by means of a cable 25. A completely leak-tight measuring device 2 is obtained by injecting the body 24 onto the mentioned elements, such that it can be washed in a dishwasher without any problem.

In this embodiment, the active communication unit 32 is arranged on the control plate 35 of the cooking apparatus 3. The active communication unit 32 communicates the temperature measured by means of the measuring device 2 to the control plate 35 of the cooking apparatus 3. The control plate 35 can, for example, thereby adapt the power of the corresponding cooking zone 31 so that the cooking temperature is kept constant, or it can give off an alarm when the cooking temperature reaches a given cooking temperature.

The following clauses disclose in an unlimited way additional implementations, with each clause representing an implementation.

Clause 1: A temperature measuring device comprising:
at least one temperature sensor (20) for measuring a cooking temperature, and
wireless transmission means for transmitting the temperature measured by the at least one temperature sensor (20) to a cooking apparatus (3),
the transmission means comprise a passive communication unit (21) configured for communicating with an active communication unit (32) of the cooking apparatus (3), the active communication unit (32) generating an electromagnetic field for feeding the passive communication unit (21), such that as a result of the electromagnetic field the measuring device (2) can measure the cooking temperature and transmit it to the cooking apparatus (3).

Clause 2: The measuring device according to clause 1, wherein the passive communication unit (21) is a passive NFC antenna.

Clause 3: The measuring device according to clause 1 or 2, comprising positioning means configured for aligning the passive communication unit (21) with respect to the active communication unit (32) of the cooking apparatus (3), such that the passive communication unit (21) of the measuring device (2) is assured to be aligned with the active communication unit (32) of the cooking apparatus (3).

Clause 4: The measuring device according to clause 3, wherein the positioning means comprise at least one magnet (22), the cooking apparatus (3) comprising means attracting the magnet, such that the passive communication unit (21) is aligned with the active communication unit (32) of the cooking apparatus (3) when both communication units approach to one another.

Clause 5: The measuring device according to clause 4, wherein the positioning means comprise a ring-shaped magnet (22), the passive communication unit (21) being arranged in the center of the ring-shaped magnet (22).

Clause 6: The measuring device according to any of the preceding clauses, comprising a body injected over the passive communication unit (21), the injected body (24) encasing the passive communication unit (21) and the body (24) being connected to the temperature sensor (20) by means of a cable (25).

Clause 7: A cooking apparatus comprising:
at least one cooking zone (31), and
wireless transmission means for receiving the temperature measured by a measuring device (2) comprising at least one temperature sensor (20),
the transmission means comprise an active communication unit (32) arranged in the cooking apparatus (3) configured for communicating with a passive communication unit (21) of the measuring device (2), the active communication unit (32) generating an electromagnetic field for feeding the passive communication unit (21), such that as a result of the electromagnetic field the measuring device (2) can measure the cooking temperature and transmit it to the cooking apparatus (3).

Clause 8: The cooking apparatus according to clause 7, wherein the active communication unit (32) is an active NFC antenna.

Clause 9: The cooking apparatus according to clause 7 or 8, comprising positioning means configured for aligning the passive communication unit (21) of the measuring device (2) with respect to the active communication unit (32) of the cooking apparatus (3), such that the passive communication unit (21) of the measuring device (2) is assured to be aligned with the active communication unit (32) of the cooking apparatus (3).

Clause 10: The cooking apparatus according to clause 9, wherein the positioning means comprise at least one magnet (33), the measuring device (2) comprising means attracting the magnet (33), such that the passive communication unit (21) of the measuring device (2) is aligned with the active communication unit (32) of the cooking apparatus (3) when both communication units approach to one another.

Clause 11: The cooking apparatus according to clause 10, wherein the positioning means comprise a ring-shaped magnet (33), the active communication unit (32) being arranged in the center of the ring-shaped magnet (33),

Clause 12: The cooking apparatus according to any of clauses 9 to 11, wherein the cooking apparatus (3) is a hob comprising a hotplate (30), the positioning means and the active communication unit (32) being arranged in the lower part (30b) of the hotplate (30).

Clause 13: A cooking system comprising:
a cooking apparatus (3) comprising at least one cooking zone (31), and
a temperature measuring device (2) comprising at least one temperature sensor (20) for measuring a cooking temperature,
the cooking apparatus (3) and the measuring device (2) comprising wireless transmission means for transmitting the temperature measured by the at least one temperature sensor (20) of the measuring device (2) to the cooking apparatus (3),
the transmission means comprise an active communication unit (32) arranged in the cooking apparatus (3) and a passive communication unit (21) arranged in the measuring device (2), both communication units being configured for communicating with one another, the active communication unit (32) generating an electromagnetic field for feeding the passive communication unit (21), such that as a result of the electromagnetic field the measuring device (2) can measure the cooking temperature and transmit it to the cooking apparatus (3).

Clause 14: The cooking system according to clause 13, wherein the active communication unit (32) is an active NFC antenna and the passive communication unit (21) is a passive NFC antenna.

Clause 15: cooking system according to clause 13 or 14, comprising positioning means configured for aligning the passive communication unit (21) with respect to the active communication unit (32), such that the passive communication unit (21) is assured to be aligned with the active communication unit (32).

Clause 16: The cooking system according to clause 15, wherein the positioning means comprise magnetic means arranged in the cooking apparatus (3) and in the measuring device (2), such that the passive communication unit (21) of the measuring device (2) is aligned with the active communication unit (32) of the cooking apparatus (3) when both communication units approach to one another.

Clause 17: The cooking system according to clause 16, wherein the positioning means comprise at least one magnet (33) arranged in the cooking apparatus (3) and at least one magnet (22) arranged in the measuring device (2).

Clause 18: The cooking system according to clause 17, wherein the positioning means of the cooking apparatus (3) comprise a ring-shaped magnet (33), the active communication unit (32) being arranged in the center of the ring-shaped magnet (33), and the positioning means of the measuring device (2) comprise a ring-shaped magnet (22), the passive communication unit (21) being arranged in the center of the ring-shaped magnet (22).

What is claimed is:

1. A temperature measuring assembly comprising:
a temperature measuring device including a temperature sensor configured to measure a cooking temperature and a passive communication unit operably coupled to the temperature sensor; and
an active communication unit that forms a part of a cooking apparatus, the passive communication unit configured to transmit data indicative of the measured cooking temperature to the active communication unit, the active communication unit configured to generate an electromagnetic field to energize the passive communication unit to enable the passive communication unit to communicate with the temperature sensor and transmit the data indicative of the measured cooking temperature to the active communication unit, the active communication unit configured to communicate the data indicative of the measured cooking temperature to a temperature controller of the cooking apparatus.

2. The temperature measuring assembly according to claim 1, wherein the passive communication unit is a passive NFC antenna.

3. The temperature measuring assembly according to claim 1, further comprising positioning means configured to align the passive communication unit with the active communication unit.

4. The temperature measuring assembly according to claim 3, wherein the positioning means includes a first magnet and the cooking apparatus includes a ferromagnetic element or a second magnet to attract the first magnet to align the passive communication unit with the active communication unit.

5. The temperature measuring device according to claim 4, wherein the first magnet is a ring-shaped magnet, the passive communication unit being arranged in a central portion of the ring-shaped magnet.

6. The temperature measuring assembly according to claim 5, wherein the passive communication unit is coupled to the temperature sensor by an electrical cable, the passive communication unit, first magnet and electrical cable being encased inside a leak-tight body.

7. The temperature measuring assembly according to claim 1, wherein the passive communication unit is coupled to the temperature sensor by an electrical cable, the passive communication unit and electrical cable being encased inside a leak-tight body.

8. A cooking apparatus comprising:
a cooking zone: and an active communication unit that is configured to generate an electromagnetic field to energize a passive communication unit associated with a temperature sensor, and to receive data from the passive communication unit indicative of a temperature measured by the temperature sensor and to communicate the data to a temperature controller of the cooking apparatus that regulates the cooking zone,

9. The cooking apparatus according to claim 8, wherein the active communication unit is laterally spaced away from the cooking zone and not located below the cooking zone.

10. The cooking apparatus according to claim 8, wherein the active communication unit is an active NFC antenna.

11. The cooking apparatus according to claim 8, further comprising positioning means configured to align the passive communication unit with the active communication unit.

12. The cooking apparatus according to claim 11, wherein the positioning means comprises a magnet.

13. The cooking apparatus according to claim 12, wherein the magnet is a ring-shaped magnet, the active communication unit being arranged in a central portion of the ring-shaped magnet.

14. The cooking apparatus according to claim 10, wherein the cooking apparatus is a hob comprising a hotplate, the positioning means and the active communication unit being located below the hotplate, laterally spaced away from the cooking zone and not located below the cooking zone.

15. A cooking system comprising:
a cooking apparatus that includes a cooking zone;
a temperature measuring device including a temperature sensor configured to measure a cooking temperature and a passive communication unit operably coupled to the temperature sensor; and
an active communication unit located inside the cooking apparatus, the passive communication unit configured to transmit data indicative of the measured cooking temperature to the active communication unit, the active communication unit configured to generate an electromagnetic field to energize the passive communication unit to enable the passive communication unit to communicate with the temperature sensor and transmit the data indicative of the measured cooking temperature to the active communication unit, the active communication unit configured to communicate the data indicative of the measured cooking temperature to a temperature controller of the cooking apparatus.

16. The cooking system according to claim 15, wherein the cooking apparatus includes a cooking zone, the active communication unit being laterally spaced away from the cooking zone and not located below the cooking zone.

17. The cooking system according to claim 15, wherein the active communication unit is an active NFC antenna and the passive communication unit is a passive NFC antenna.

18. The cooking system according to claim 15, further comprising positioning means configured to align the passive communication unit with the active communication unit.

19. The cooking system according to claim 18, wherein the positioning means includes magnetic means arranged in the cooking apparatus and in the measuring device.

20. The cooking system according to claim 19, wherein the positioning means includes a first magnet arranged in the cooking apparatus and a second magnet arranged in the measuring device.

21. The cooking system according to claim 20, wherein the first magnet is a ring-shaped magnet with the active communication unit being arranged in central portion of the ring-shaped magnet, and the second magnet is a ring-shaped magnet with the passive communication unit being arranged in a central portion of the ring-shaped magnet.
